(19) United States
(12) Patent Application Publication
(10) Pub. No.: US 2004/0012169 A1
(43) Pub. Date: Jan. 22, 2004

(54) Tricycle structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/196,133

(22) Filed: Jul. 17, 2002

(51) Int. Cl. B62K 5/06; B62K 9/02; B62K 15/00

(52) U.S. Cl. 280/282; 280/287

(57) ABSTRACT

A tricycle structure comprises a rear frame secured to a main frame of the tricycle. The structure of securing the two parts is a quick-released type, which comprises a pair of sleeves at the rear end of the main frame with a through hole, respectively. The rear frame has a pair of posts corresponding to the sleeves of the main frame. Each post has an elastic element with a knob which is urged to extend through the corresponding hole of the sleeve. While the posts are inserted into the sleeves, the main frame holds the rear frame firmly.

### FIELD OF THE INVENTION

This invention relates to a tricycle, more particularly to a tricycle with a detachable main frame and a detachable rear frame.

### BACKGROUND OF THE INVENTION

Most tricycles on market are designed to balance the tricycle so that a child will not fall or out of balance. This design is to connect a front fork to a main frame and a rear frame connected to the bottom end of the main frame, two wheels are mounted on the rear frame and one wheel is mounted on the front frame, respectively. A crank is secured to the bottom end of the front fork and a handle is secured to the upper end of the front fork, respectively. Thus, a rider may seat on the tricycle and step on the peddles to drive the tricycle forward or backward.

The prior art has a fixed body, which takes a lot of space to store. Therefore, a foldable tricycle was derived, which is to collapse or to bend the main frame to minimize the size. However, this design has too many joints, which consumes times both in manufacture and to disassemble or to assemble the tricycle.

### SUMMARY OF THE INVENTION

It is the primary object of the present invention to provide a tricycle structure, which is easy to assemble or to disassemble.

It is another object of the present invention to provide a tricycle structure, which saves storage space.

It is a further object of the present invention to provide a tricycle structure, which consumes less time in assembling, thus is cost effectiveness.

### BRIEF DESCRIPTION OF THE DRAWINGS

FIG. 1 is an exploded view of the present invention;

FIG. 2 is a perspective view of the present invention;

FIG. 3 is a side view of the present invention, and

FIG. 4 is a top sectional view of the rear frame of the present invention.

### DETAILED DESCRIPTION OF THE PREFERRED EMBODIMENT

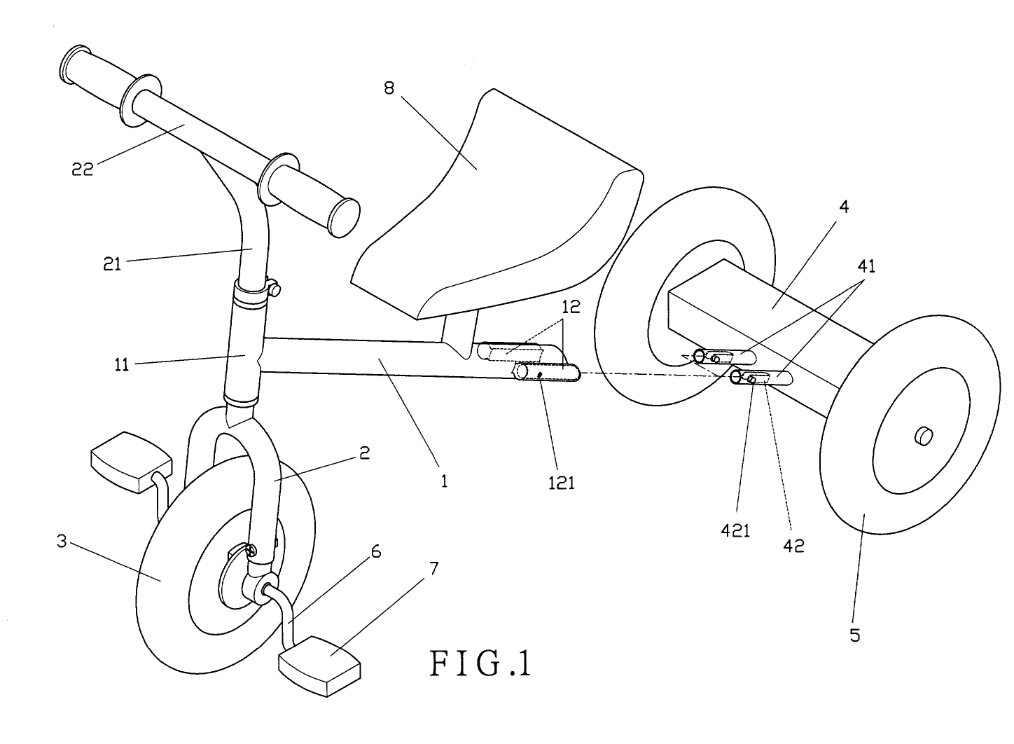

A tricycle structure of the present invention, as shown in FIG. 1, comprises a main frame 1 which has a front pipe 11 for connection with a front fork 2. The bottom end of the front fork 2 is connected with a front wheel 3. A seat 8 is coupled to the main frame 1. The rear end of the main frame 1 is connected with a rear frame 4 having a pair of rear wheels 5 connected thereto. The front wheel 3 is connected with a crank 6 and pedals 7. A handle 22 is connected to the top end of a front stem 21 which is secured to the front pipe 11.

The main frame 1 comprises a pair of sleeves 12 at the rear end. Each of the sleeves has a hole 121.

The rear frame 4 comprises a pair of posts 41 corresponding both in size and position to the two sleeves 12 of the main frame 1. Each post 41 has an elastic part 42 with a knob 421 urged to extend outwardly.

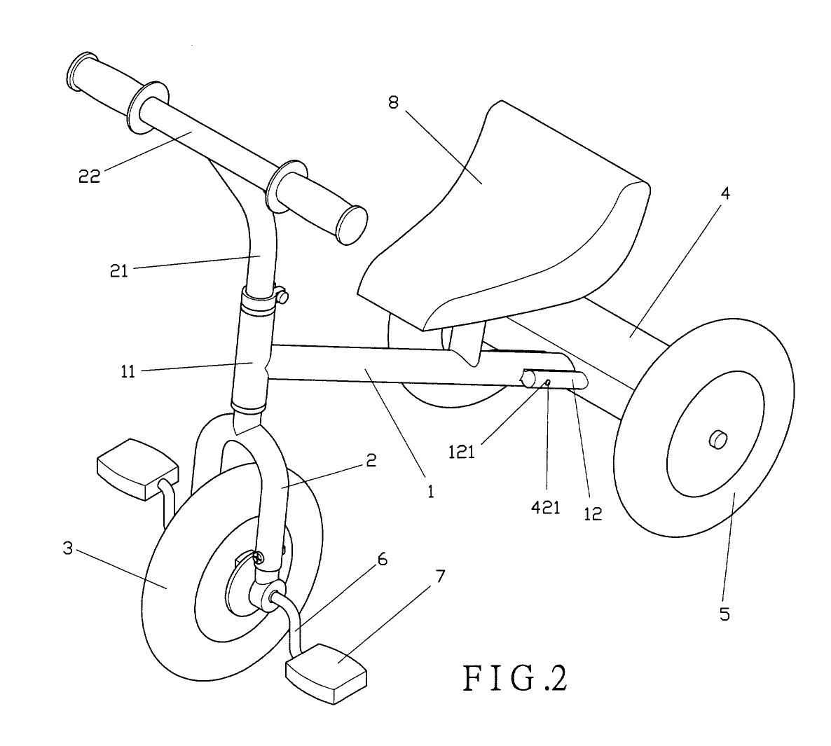

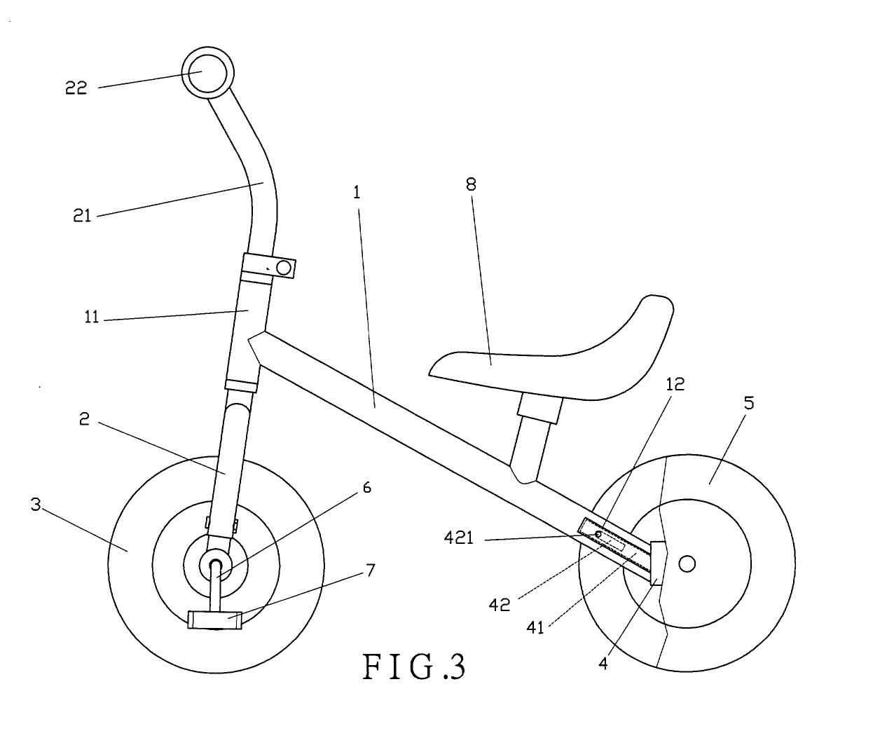

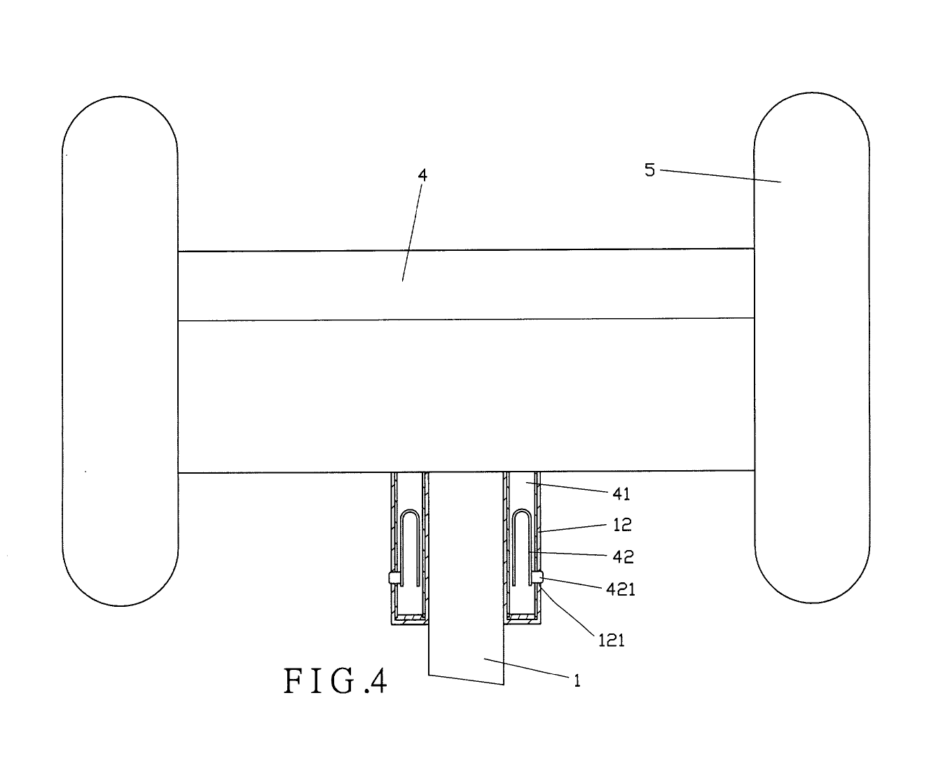

To assemble the present invention, the rear frame 4 is aligned to the main frame 1, as shown in FIGS. 2, 3, 4, the two posts 41 are inserted into the corresponding sleeves 12 all the way until the elastic parts 42 have reached the holes 121, whereas the knobs 421 are urged outwardly, thus the rear frame 4 is secured to the main frame 1.

To disassemble the present invention, the knobs 421 are pressed down, which allows the posts 41 to disengage from the sleeves 12, thus the rear frame 4 is free to pull out from the main frame 1 and is ready to store in a compact space.

I claim:

1. A tricycle structure comprising a main frame having a pair of sleeves at a rear end with a hole on each said sleeve, a rear frame having a pair of posts corresponding both in size and in position to said sleeves of said main frame, each of said posts having a knob being urged outwardly by an elastic element, thus upon said posts being inserted into said sleeves, said knobs being urged outwardly from said holes of said sleeves;
to assemble, said posts of said rear frame being inserted into said sleeves of said main frame until said knobs having reached to said holes of said sleeves and urged to extend outwardly therefrom; to disassemble, said knobs of said posts being pressed down so that said rear frame being free to detach from said main frame.
